(19) United States
(12) Patent Application Publication
(10) Pub. No.: US 2012/0185273 A1
(43) Pub. Date: Jul. 19, 2012

(54) Electronic complete health information facilitator

(76) Inventor: Carmen Elena Marianovich, Washington, DC (US)

(21) Appl. No.: 12/930,797

(22) Filed: Jan. 18, 2011

(51) Int. Cl. G06Q 50/00; G06Q 10/00

(52) U.S. Cl. 705/3

(57) ABSTRACT

e-CHIF eliminates the inconsistency and duplication of Patient Records by centralizing the data in only one place, the e-CHIF database. Using a web based portal, a health provider initially adds the patient record. The patient owns the data and makes it available to subsequent health providers including physicists, dentists, psychiatrics, and alternative medicine practitioners who add additional data to the patient record. Therefore a patient or an authorized health provider can view the complete health history of a person including conventional and alternative medicine treatments. Additionally, the health provider using the e-CHIF web site has the capability to electronically submit an insurance claim, request a prescription to a pharmacy, or a test to a laboratory. To assist the patient, health providers, and medical research several statistical reports without personal identifiable information can be generated using the e-CHIF data.

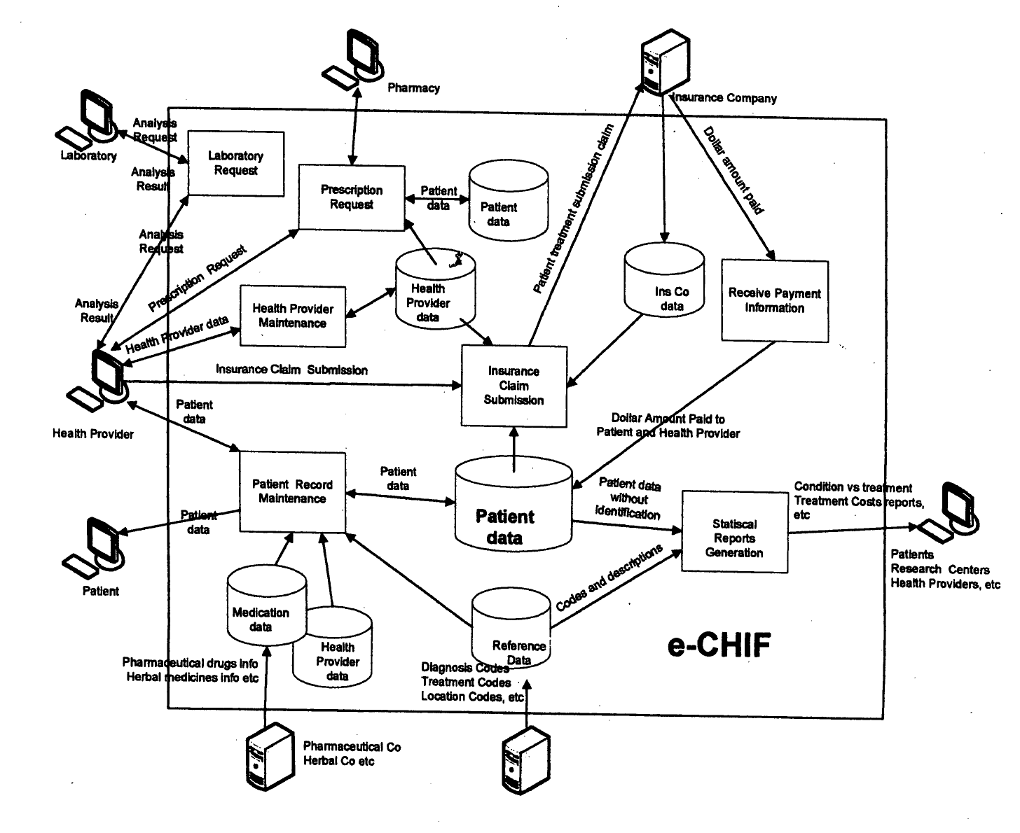

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

My invention, e-CHIF, is a patient data processing application. Currently, there are several problems with the access to health care and patient data that contribute to the huge health care costs in the USA and make difficult the selection of the best treatment for a health condition.

The patient data is duplicated. Every time a patient goes to a new health provider (doctor, dentist, psychiatric, acupuncturist, etc) must provide the same personal and health history. This unnecessary duplication contributes to health care costs.

The information a health provider has of a patient is in many cases incomplete and unreliable. The patient's recollection is one source of the data and he may forget to mention medications, tests, etc. In many cases, information about alternative medicine used by the patient such as acupuncture, reiki, etc is not mentioned to the physician.

There is not one unique place the patient can go to retrieve his complete health history and treatments cost.

The patient data does not easily flow from some health providers to the pharmacy, laboratory, and insurance and time is lost in faxes and telephone calls querying for the status of a prescription or laboratory request.

When a patient or health provider are evaluating possible options to treat a health condition, the data about different treatments are scattered in different places and there is not enough data to evaluate alternative medicine treatments although many of them are cheaper and less invasive than traditional medicine. Since there is not a monetary gain for laboratories in alternative medicine treatments, no money is allocated to collect and analyze alternative medicine results.

### BRIEF SUMMARY OF THE INVENTION

e-CHIF eliminates the inconsistency and duplication of Patient Records by centralizing the data in only one place, the e-CHIF database. Using a web based portal, a health provider initially adds the patient record. The patient owns the data and makes it available to a subsequent health provider who adds additional data to the patient record. This capability decreases the administrative cost and resources across the spectrum of involved parties: health providers, patients, etc.

Another purpose of the system is to facilitate the flow of information among health providers, patients, and insurance companies. e-CHIF provides the health provider the capability of using the e-CHIF web site to electronically submit an insurance claim, request a prescription to a pharmacy, or a test to a laboratory. Time consuming phone calls and other means of communication among health provider, patient, insurance companies and pharmacies currently used to query the status of a request or claim is replaced by easy queries using the e-CHIF portal.

The patient or an authorized health provided has easy access to the complete patient data through a web site user interface.

e-CHIF's centralized data and automated processes ensures integrity, reliability, and confidentiality,

Additionally, reports are provided that assist the user of the system to take more effective and informed decisions when selecting treatments, health providers, and insurance companies.

### BRIEF DESCRIPTION OF THE SEVERAL VIEWS OF THE DRAWING

1. c-CHIF—System Architecture

### DETAILED DESCRIPTION OF THE INVENTION

e-CHIF includes the following functions:
1. Patient Record Maintenance
2. Submission of a Claim to an Insurance Company
3. Reference codes Maintenance
4. Drug Maintenance
5. Health Provider Maintenance
6. Parties Maintenance
7. Security
8. Reports

1. Patient Record Maintenance

Using e-CHIF web based secure interface, a Health Provider initially creates the Patient Record selecting the appropriate service, procedure and other codes from lists provided by the system. To ensure confidentiality of the data the patient sets a password. e-CHIF validates the data and stores the Patient Record in e-CHIF databases. Once the Patient Record is established, the patient or a user authorized by the patient can view the Patient Record from the web site. Also, a subsequent health provider authorized by the user can add additional data to the record about a new health condition, procedure, etc. Therefore, the Patient Record will contain the complete health history of a person including medical conditions, treatments, charges, etc. Additional features of this web user interface will be:
1 Submission of a claim to an insurance company
2 Send a prescription request to a pharmacy
3 Send a test request to a laboratory
4 Several queries about the status of a prescription request, insurance claim status etc.

Benefits

This function will eliminate the current duplication and inconsistency of Patient Records by centralizing the data in only one place, the e-CHIF database. Therefore, this capability will dramatically decrease the administrative cost and resources across the spectrum of health providers.

Time consuming phone calls and other means of communication currently used to query the status of a request or claim will be replaced by easy queries using the e-CHIF portal.

2. Submission of a Claim to an Insurance Company

The Insurance Claim processing consists of the following:
1. The health provider submits a claim to an Insurance Company selected from an Insurance Company list displayed by the system.
2. Using the Patient Record, Heath Provider, Insurance Company data, e-CHIF creates a claim and electronically transmits it to the Insurance Company.
3. After receiving the electronic claim from e-CHIF, the Insurance Company notifies e-CHIF receipt of claim and amount covered by the insurance. This data is stored in e-CHIF and it is available to the patient and health provider using the query features of the e-CHIF portal.
4. When the Insurance Company pays the Health Provider or the Patient, it sends an electronic message to e-CHIF with the dollar amount paid that is stored in the e-CHIF database and the claim is closed.

3. Reference Codes Maintenance

Allows for the storage in e-CHIF of several reference codes used by the system to categorize, validate and process the data. Following are some of the codes that will be maintained in e-CHIF system.
1 Medical Codes such as symptoms codes, diagnosis codes, medical test codes, procedure codes etc . . .
2 Location Codes such as state, country, zip code, etc . . .
3 Processing Codes. These are codes used by the system for processing the data such as: processing stage, payment status, etc . . .

The codes with the description will be extracted from the institutions responsible for defining the Medical and Location codes

4. Drug Maintenance

Drug information such as drug name, composition, use, side effects, cost, etc. . . will be extracted from the responsible pharmaceutical company. Additionally, basic information (company name, address, phone, contact information) about the pharmaceutical company will be maintained. This data will be also available for displaying using the e-CHIF web site.

5.Health Provider Maintenance

This function allows the Health Provider (physician, surgeon, dentist, psychiatrist, alternative medicine practitioner, acupuncturist, . . . ) to establish an account and password. Once the Health Provider public data (Name, address, contact info, phone, fax, etc) is added to e-CHIF, part of this data will be available through the e-CHIF web site to the health insurance, the laboratory, and other users. A health provider in e-CHIF is any person that treats a patient health condition. It includes a conventional medicine provider such as a physician and also complementary medicine providers such a as reiki, acupuncture, chiropractic, etc . . .

Benefits

e-CHIF will store information about health conditions and different treatments used by patients to treat that condition including conventional medicine and complementary medicine treatments. Therefore, the collected data will allow to comparison and measurement of the effectiveness of a treatment (Conventional or alternative).

6. Party Maintenance

e-CHIF provides the capability to add and maintain public data (Company Name, address, contact information, phone, etc) about the following parties:
1 Insurance Company
2 Pharmacy
3 Laboratory

This data will be accessed by e-CHIF when validating and processing insurance claims. The data will be available to the user in the e-CHIF web site.

7. Security

Currently Patient Record data is not well protected. It is duplicated and stored in the offices of several doctors, dentists, hospitals, and insurance companies in paper files and several systems, some with dubious protection. e-CHIF will eliminate this duplication and will have strong security features to protect the confidentiality and integrity of the data, ensuring that only the authorized user can view the data and only the part of the data he is authorized to view.

8. Reports

Several statistical reports without personal identifiable information can be generated using the e-CHIF data. One of the possible uses is Medical Research

### Example

1 Report that lists the result of different treatments (procedures, drugs etc) for a particular medical condition.
2 Treatment Cost Determination

### Example

1 Report that lists the cost of different treatments (procedures, drugs, etc) for a particular condition.

1. The invention in which an exclusive property or privilege is claimed is a web-based patient data application system comprising the following automated functions: initial creation of a patient record in a database by a health provider, additional medical and cost data added to the patient record by any other subsequent health provider authorized by the patient, capability for the patient to browse their own medical history data, capability for a health provider to browse all the medical records of his own patients, submission of an electronic claim to an insurance company, electronic transmission of a prescription request to a pharmacy, electronic transmission of a test request to a laboratory, maintenance of a health provider data, statistical reports generation.

2. The invention in which an exclusive property or privilege is claimed is the web-based patient data application system of claim 1 further comprising the following automated functions: receipt notification from insurance company of amount covered, receipt prescription status from pharmacy, receipt and storing of test results from laboratory, storage of insurance company related data, storage of pharmacy and laboratory contact data, loading of reference codes including medical codes, display drug information, generation of statistical reports including results and cost for treatment by conditions.
